(19) United States
(12) Patent Application Publication
(10) Pub. No.: US 2006/0215648 A1
(43) Pub. Date: Sep. 28, 2006

(54) SYSTEM AND METHOD FOR HARDWARE BASED PROTOCOL CONVERSION BETWEEN AUDIO-VISUAL STREAM AND IP NETWORK

(76) Inventor: Teng-Yi Jen, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 10/907,151

(22) Filed: Mar. 22, 2005

(51) Int. Cl. H04L 12/56; H04L 12/28

(52) U.S. Cl. 370/389

(57) ABSTRACT

A system for transferring audio-video data via network includes an audio-video data source, circuits for encapsulation and de-capsulation of the audio-video data, a plurality of network adapters, and a network. The system offloads encapsulation and de-capsulation tasks from a general-purpose processor to its own processors to reduce system load and hardware requirements, and is capable of functioning with a variety of networking standards.

### BACKGROUND OF INVENTION

1. Field of the Invention

The present invention applies to the transfer of packetized audio-visual data via a network, and more particularly to hardware based dynamic encapsulation of transport stream, program stream, or elementary stream packetized audio-visual data within a network protocol data format prior to transmission, and post-transmission hardware based dynamic de-encapsulation for audio sound and visual image play back.

2. Description of the Prior Art

As the cost of computing power and networking equipment declines, the networking of multimedia devices is no longer common only in office and professional environments, but is becoming increasingly common in the home. This opens up possibilities for enhanced distribution of entertainment content throughout, for example, a household, although in order to realize further cost reductions in the design and manufacture of content distribution equipment, simplification of said devices will generally be required.

Streamed Audio-Visual (AV) data is commonly referred to as an Elementary Stream (ES). For output purposes, an elementary stream may be subject to a packetizing process, thereby becoming a Packetized Elementary Stream (PES). According to the Moving Picture coding Experts Group 2 (MPEG2) standard, two streams that are defined for transmitting a PES are the Program Stream (PS) format and the Transport Stream (TS) format.

PES data is routinely transported between such devices as, for example, Digital Video Broadcast (DVB) tuners, digital cameras, Digital Versatile Disc (DVD) players, notebook Personal Computers (PCs), Personal Digital Assistants (PDAs), mobile phones etc. The Program Stream (PS) format and the Transport Stream (TS) format have their merits and demerits and so, depending upon the format and to which environment has been applied, a conversion process may be required according to the type of application used to link transmitting and receiving devices. For example, a packetized elementary stream (PES) initially to form a program stream (PS) stored in Digital Versatile Disc (DVD), may be converted to transport stream (TS) format prior to transmission via a wireless link.

The above is sometimes necessary because, under TS methodology, AV data is arranged into fixed-length data packets. This not only makes it easier (as compared to methodologies using variable-length data packet schemes) for hardware to process the data, but also allows easier implementation of error correction schemes. TS methodology does, however, carry the disadvantage that bandwidth usage is heavier due to the additional number of headers required over a variable-length data packet scheme.

Under PS methodology, AV data is arranged into variable-length data packets. For example, with Digital Versatile Disc (DVD) AV data, the data packets need not be of any fixed length, but instead may be variable length, hence the PS format is well suited to transporting such data. However, unlike TS data, data transmitted under the PS scheme cannot easily be checked for errors, hence transmission of such data via error prone links is avoided. Please also note that a program stream carrying, for example, the above-mentioned DVD AV data, is further made up of several sub-streams, and generally at least includes an audio stream and a video stream.

Neither of the PES related formats above-mentioned, however despite their respective merits, are compatible with network protocols such as the Internet Protocols (IPs). Internet protocols are commonly used for data transfer in computer networks and hence are referred to by way of example. Here an AV stream will be used as an example to represent all PES related formats (such as PES, TS and PS). Any AV stream packets distributed out from, for example, content distribution equipment, would require conversion to a compatible data packet format, and also correct addressing before it could be forwarded to a target device on an IP network. TS stream packets can be identified by Program Identifier (PID) carried in the header of each TS stream packet, so in order for a distribution system to fulfill the above two requirements, the distribution system would have to include a means of filtering such data, and a means for converting the TS stream packets into IP packets.

An example of a prior art system for distributing AV data to network enabled devices is a television Set Top Box (STB) server. FIG. 1 is a block schematic diagram depicting a television STB server system and user networked devices 10, capable of receiving a multi-program TS, de-multiplexing the TS data to re-form the AV program/programs, and addressing and distributing the AV programs to downstream user devices. The television STB server 100 comprises a DVB tuner 101 for receiving an incoming multi-program signal 15, a demodulator 102 for separating the carrier wave from the multi-program transport stream, a de-multiplexer (DEMUX)/PID filter 103 for separating the various AV programs within the multi-program transport stream, and for extracting PID data for each data packet, a PID to Internet Protocol (IP) address mapping unit 104 for translating the PID data of each packet into the IP addresses of target network devices, a packet converter 105 for converting packet format (from, for example MPEG2 format, to IP packet format), and a router 106 for routing the IP packets to an appropriate network or network enabled devices 11˜14.

U.S. Pat. No. 6,785,733, issued to Mimura et al. and incorporated herein by reference, discloses such a packet conversion system. In Mimura et al., encapsulation of video data requires a CPU and DMA accessing of multiple buffers for stripping of headers, packet construction, and encoding the PID number into the IP address. A buffer is utilized to store an entire received IP packet, which is subsequently disassembled to regain the video stream using the decoded IP address to obtain the corresponding PID number.

The simplified overview above, belies the complexity of such devices as the set top box server 100, the functions carried out by the de-multiplexer/PID filter 103, PID to Internet Protocol (IP) address mapping unit 104 and packet converter 105 in particular, are complex and require the allocation of significant amounts of memory space and processing power. Therefore, devices such as the set top box server 100 generally have an integral central processor unit (CPU) or micro-controller of reasonable power and reasonable memory space. Without adopting a different approach to implementing the above-mentioned prior art element, the simplification required in order to allow production cost reduction is limited. There is a need then to identify and implement such an approach in the interests of overcoming the drawbacks of the prior art.

### SUMMARY OF INVENTION

Therefore, one objective of the claimed invention is to provide an efficient method for AV program data transfer, which reduces processor and memory usage.

14 Another objective of the claimed invention is to provide a system for AV program data transfer utilizing encapsulation hardware at a source and de-capsulation hardware at a receiver, using a standard means of networking to form a link between the encapsulating hardware to the de-capsulating hardware.

The claimed invention thus provides a system and method for hardware based protocol conversion between audio-visual stream and IP network comprising an AV stream encapsulate circuit and an AV stream de-capsulate circuit.

The claimed invention further provides an AV stream encapsulate circuit for encapsulating AV stream data packets into IP network packets, comprising a control circuit, a packet header length counter, a packet header memory, an AV stream FIFO, and a packet payload length counter. Also provided is an AV stream de-capsulate circuit for de-capsulating AV stream data packets from an IP network packet, comprising a control circuit, a packet header removal counter, a packet end detector, an AV stream FIFO, and a AV stream shaper.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block schematic diagram depicting a television ‘set top box’ (STB) server audio-video content distribution system according to the prior art.

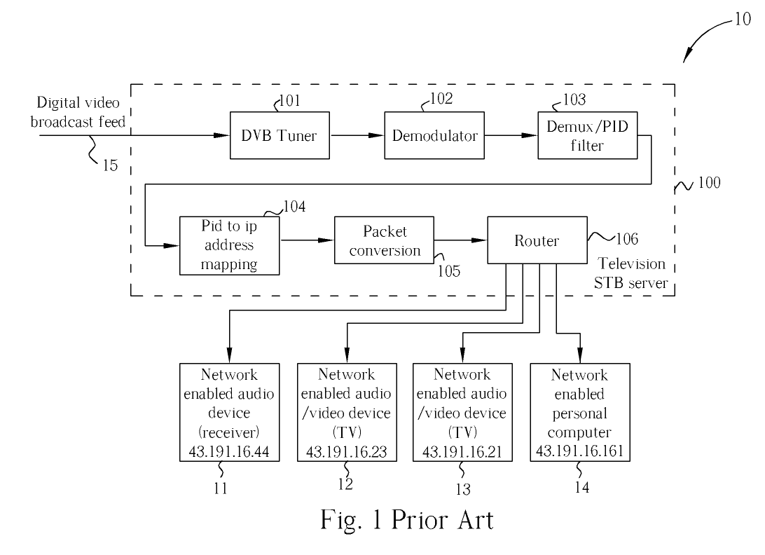

FIG. 2 is a block schematic diagram of the present invention system for a system and method for hardware based protocol conversion between audio-visual stream and IP network.

FIG. 3 shows an encapsulated TS packet in TCP/IP or UDP/IP format.

FIG. 4 is a block schematic diagram of a preferred embodiment of the AV stream encapsulation circuit in FIG. 2.

FIG. 5 is a block schematic diagram of a preferred embodiment of the AV stream de-capsulation circuit in FIG. 2.

FIG. 6 shows a block diagram of the method of the AVSEC of the present invention when encapsulating PS or PES data.

FIG. 7 shows a block diagram of the method of the stream shaper of the present invention when receiving TS data.

FIG. 8 shows a block diagram of the method of the stream shaper of the present invention when receiving PS or PES data.

### DETAILED DESCRIPTION

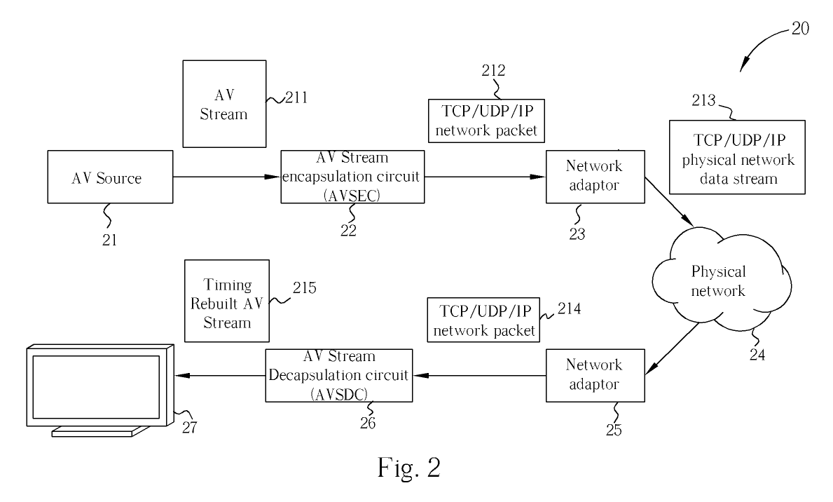

Please refer to FIG. 2, which is a block schematic diagram of a preferred embodiment 20 related to a present invention system for a system and method for hardware based protocol conversion between audio-visual stream and IP network. Working from source to end user device, the system includes an Audio-Video (AV) source 21, which as discussed above may be a device such as a Digital Versatile Disc (DVD) player. The AV stream 211 outputs from the Audio-Video (AV) source 21, which may comprise a stream of Packetized Elementary Stream (PES), Transport Stream (TS), or Program Stream (PS) data packets, is input to an AV Stream Encapsulate Circuit (AVSEC) 22. The AV Stream Encapsulate Circuit (AVSEC) 22 dynamically encapsulates each AV stream data packet or series of data packets (depending upon the nature of PES, TS, or PS) of the AV stream 211 by converting the entire data packet into the payload data of a network protocol data packet. In the example shown, the required network protocol is an Internet Protocol (IP), more specifically, a Transmission Control Protocol/Internet Protocol (TCP/IP). Hence, the AVSEC 22 will append each AV stream data packet or series of data packets, to an appropriately addressed TCP/IP header to form a TCP/IP network packet 212.

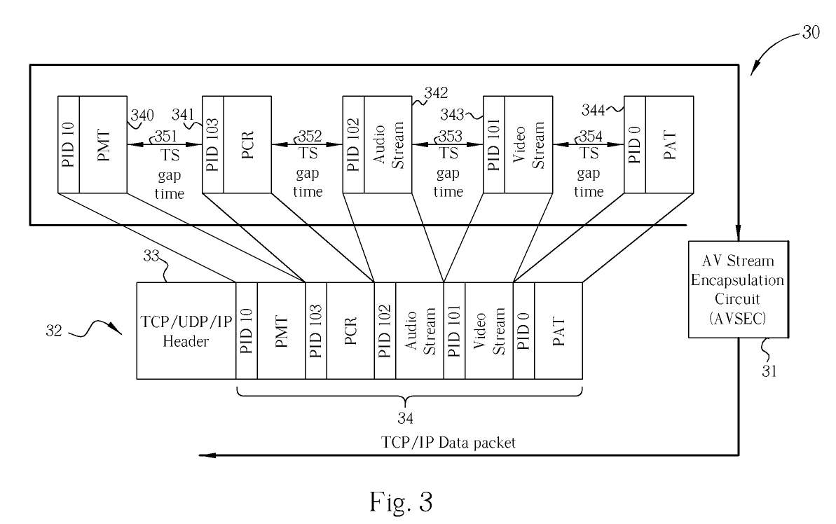

As mentioned above, the AV stream 211 may comprise PES data, TS data or PS data. When the AV stream 211 comprises TS data, the AVSEC 22 may be required to concatenate and encapsulate a series of TS packets that have been distributed by AV source 21. An illustration of this case is shown by FIG. 3, where TS packets have timing relationships among all packets by using TS gap times 351-354 to represent time information. A group of TS data packets 340˜344 having removed timing relationships among all TS data packets are concatenated as payload data 34, along with a TCP/IP Header 33, to form a TCP/IP network packet 32. For Audio/Video playing back, the timing relationships among all TS packets should be rebuilt. An AV stream shaper in AV stream de-capsulation circuit to rebuild the timing relationship will be discussed later.

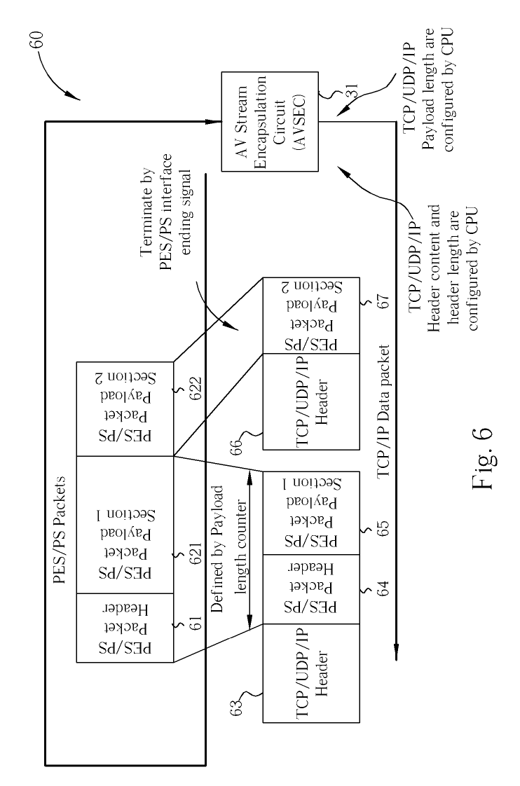

Please refer to FIG. 6, which shows a block diagram of the method of the AVSEC 22 of the present invention when encapsulating PS or PES data. The AVSEC 22 is configured during initialization by the CPU with the payload length and header content and header length. As each PS/PES packet enters the AVSEC 22, the AVSEC 22 encapsulates the PS/PES packet into one or more TCP/IP or UDP/IP network packets for network transmission. It does this by building a network packet header 63, then appending data bytes 61, 621 of the PS/PES data while decrementing the packet payload length counter 225. Once the packet payload length counter 225 reaches zero, the network packet is encapsulated. If more data exists (622), another network packet is outputted comprising a network packet header 66, which is the same as network packet header 63, and the additional data 622. Encapsulation of the another network packet is completed when the interface of the AV source 21 signals the end of the PS/PES packet. The AVSEC 22 repeats to segment the entire PS/PES packet until the PS/PES end is signaled by the interface of AV source 21. Although FIG. 6 shows the PS/PES packet being segmented into two network packets, in general a PS/PES packet can be segmented into one or more network packets depending on its length and the transmission requirements configured during initialization.

The TCP/IP network packet 32 corresponds to the TCP/IP network packet 212 of FIG. 2. Referring again to FIG. 2, TCP/IP network packet 212, while conforming to the network protocol, may not have the correct physical characteristics to be compatible with the physical network. That is, the voltage levels and/or clocking regime at which the AVSEC operates may not be the same as that used by the physical network, indeed, data transmission may be by means of optical fiber. Hence, a network adaptor 23 is included to convert an input TCP/IP network data packet 212 into a TCP/IP physical data stream packet 213. The network adapter 23 creates the TCP/IP physical data stream packet 213 and then sends the TCP/IP physical data stream packet 213 onto the physical network 24. The conversion process may include, but is not limited to, galvanic level, frequency, duty cycle, or copper-to-fiber adaptation.

Once output to the physical network 24, the TCP/IP physical data stream packet 213 should be delivered to an IP address of a target network enabled device. Generally, a network adaptor 25 will be required to carry out the reverse process to that carried out by the network adaptor 23 described above. The network adapter 25 receives the TCP/IP physical network data packet 213 from the physical network 24 The output of the network adaptor 25, which is a TCP/IP network data packet 214 and should be identical to the TCP/IP network data packet 212, is input to the AV Stream De-capsulation Circuit (AVSDC) 26. The AVSDC 26, having been configured for the appropriate protocol upon initialization, removes the TCP/IP header from the TCP/IP network data packet 214 and stores the payload data only. Since the TCP/IP network data packet 214 payload data is effectively the original AV stream 211 output from the Audio-Video (AV) source 21, the AVSDC 26 outputs the payload data via an internal AV Stream Shaper circuit (not shown) as a timing rebuilt AV stream 215. The timing rebuilt AV stream 215 is then distributed to an end user device(s), which in this example is an AV Play Back device 27.

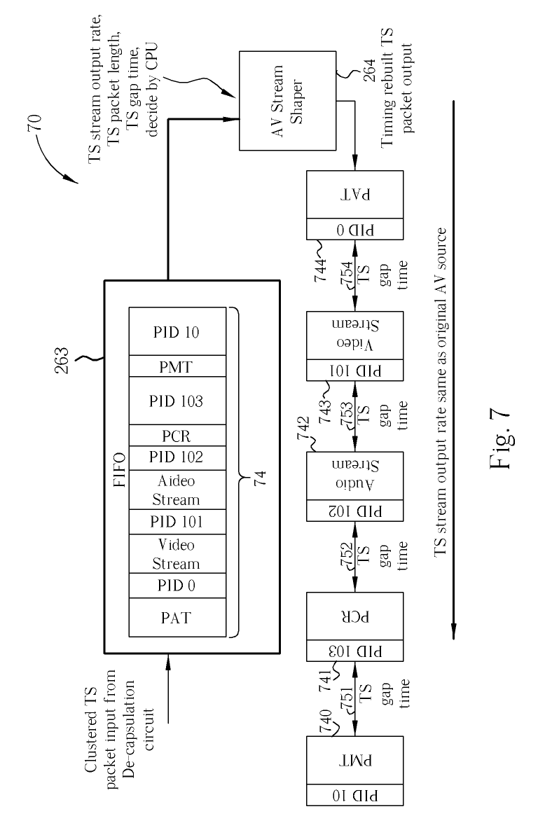

Please refer to FIG. 7, which shows a block diagram of the method of the stream shaper of the present invention when receiving TS data. The FIFO (first in first out memory queue) 263 has received the clustered TS packets 74 from the control circuit (not shown) of the AVSDC 26. The control circuit of the AVSDC 26 has already stripped the TCP/IP or UDP/IP header from the network packet 214 to form the clustered TS packets 74. The timing information between the various TS packets in the AV stream 211 was eliminated when the TS packets were packed into the clustered TS packet 74, and must be rebuilt by the AV Stream Shaper 264. The data is sent to the AV Stream Shaper 264, which has been initialized during setup with parameters such as the TS stream output rate, TS packet length, and TS gap time. This information was provided by the AVSEC 22, which recognize PES/PS output rate, TS stream output rate, TS packet length, and TS gap time from the AV Source 21 and sends those information to the AVSDC 26 during an initialization phase.

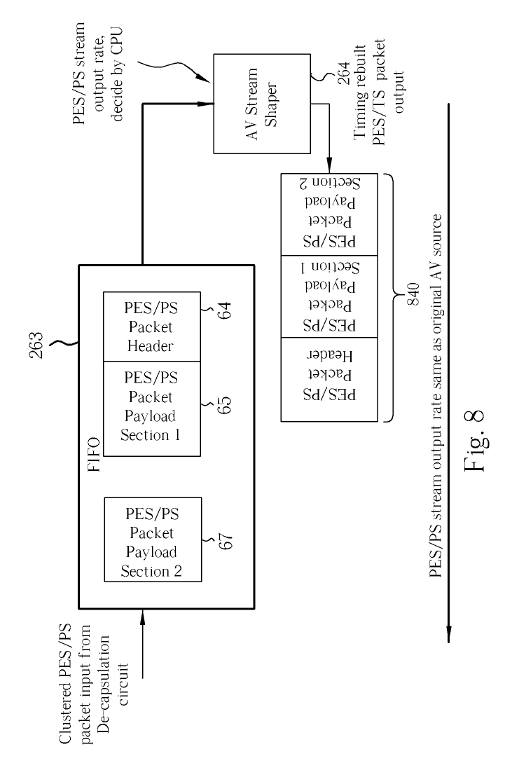

Please refer to FIG. 8, which shows a block diagram of the method of the stream shaper of the present invention when receiving PS/PES data. The FIFO 263 has received a series of PS/PES packet segments 64, 65, and 67 from the control circuit (not shown) of the AVSDC 26. The control circuit of the AVSDC 26 has already stripped the TCP/IP or UDP/IP headers from the network packet 214 to form the PS/PES packet segments 64, 65, and 67. The FIFO 263 receives as many PS/PES packet segments as are necessary to reconstitute the original PS/PES packet. This example only shows three PS/PES packet segments 64, 65, and 67 for simplicity, but in general, the original PS/PES packet could be split into one or more segments for TCP/IP or UDP/IP transmission. Once the entirety of packet segments necessary to reconstitute the PS/PES packet has been accumulated in the FIFO 263, the PS/PES packet 840 is created by the AV Stream Shaper 264 with same data flow rate of original PS/PES packet of the AV source 21. Because the data flow rate of the PES/PS packets was lost during encapsulation and must be rebuilt by the AV Stream Shaper 264, the data flow rate parameters are sent from the AVSEC 22 to the AVSDC 26 during an initialization step, such that AVSDC 26 configures the AV stream shaper 264 for rebuilding the data flow rate of original PS/PES packet of the AV source 21. Therefore, the AV stream shaper 264 rebuilds the timing between PS/PES packets and outputs each packet as its original timing information, thus reconstituting the original AV stream.

In the above, TCP/IP is cited by way of example and the present invention is in no way limited to a single protocol. Other protocols including User Datagram Protocol/Internet Protocol (UDP/IP) may also be accommodated.

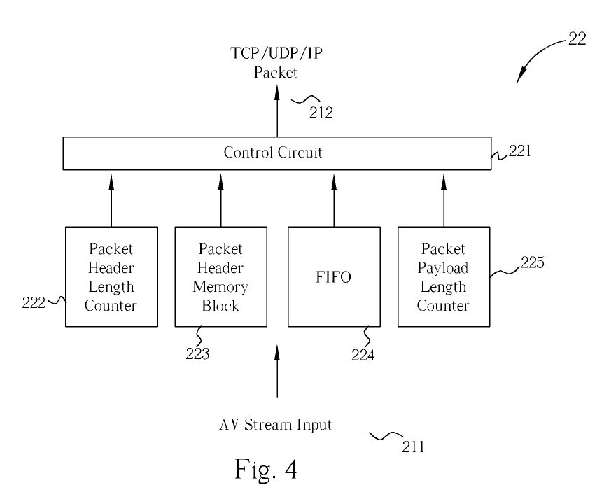

FIG. 4 shows a block schematic diagram of an AV Stream Encapsulation Circuit (AVSEC) 22 (the same as item 22 in FIG. 2 above). The AVSEC 22 comprises a control circuit 221, a packet header length counter 222, a packet header memory block 223, a First-In-First-Out memory block (FIFO) 224, and a packet payload length counter 225.

The AVSEC 22 is configured upon initialization, generally by a content configuration controller (not shown), to operate in accordance with a relevant network protocol. To continue with the example as given in FIG. 2 above, network protocol can be assumed to be TCP/IP. In preparation for incoming data bytes of the AV stream 211, the AVSEC 22 forms an IP header in a packet header memory block 223. (At this stage, however, the IP header is not issued because an incoming AV stream data has not yet been identified.) Also, the packet header length counter 222 is set according to the length of the IP header in the packet header memory block 223, and the packet payload length counter 225 is configured according to user customized payload length. When an incoming data bytes of the AV stream 211 is input to the AVSEC 22, it is loaded into FIFO 224; the packet payload length counter 225 simultaneously counts the number of AV stream data packet data bytes, thus recording the length of the AV stream data packet. As the AV stream data bytes are loaded into FIFO 224, the control circuit 221 can then output the TCP/IP header (item 33 in FIG. 3), which includes the correct IP address.

Referring again to FIG. 4, as the TCP/IP header is output from the control circuit 221, the packet header length counter 222 counts the number of data bytes. When the state of the packet header length counter 222 signifies that the last data byte of the packet header is output, the contents of FIFO 224 are output directly sequential to the TCP/IP header. The data bytes in FIFO 224 will continue output as TCP/IP packet payload when packet payload length counter 225 reveals “continue counting state”. Meanwhile the data bytes of AV stream 211 continue to input to FIFO 224 until the packet payload length counter 225 signifies that the last data byte of packet payload has arrived. When touching the last data byte, packet payload length counter 225 reveals “counting end state” to inform the control circuit 221 to finish the current encapsulation process and wait for the next encapsulation process.

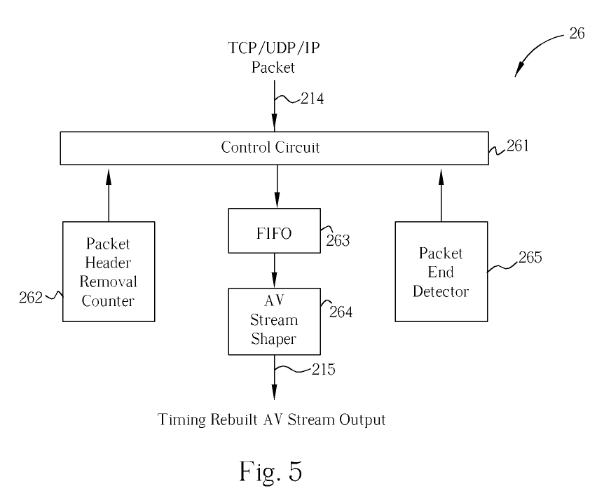

FIG. 5 shows a block schematic diagram of an AV Stream De-capsulation Circuit (AVSDC) 26 (the same as item 26 in FIG. 2 above). The AVSDC 26 comprises a control circuit 261, a packet header removal counter 262, a FIFO memory block 263, an AV Stream Shaper 264, and a packet end detector 265.

The AVSDC 26 is configured upon initialization, generally by a content configuration controller (not shown), to operate in accordance with a relevant network protocol. To continue with the example as given in FIG. 2 above, the network protocol can be assumed to be TCP/IP. At initialization, the Packet Header Removal Counter 262 is given the length of the packet header of the relevant network protocol so that the unwanted network packet header can be removed based on the length information of Packet Header Removal Counter 262. When an incoming TCP/IP network data packet 214 is input to the AVSDC 26, the control circuit 261 discards the TCP/IP header 33, 63, 66, using the packet header removal counter 262 to count through the bytes in the header until it has been discarded, saving the packet payload length which is parsed from the network packet header for use in the packet end detector 265, putting the payload data 34 or payload data 64, 65, 67 into the FIFO 263 until the packet end detector 265 detects that the data has been fully received. The FIFO 263 then delivers the payload data 34 or payload data 64, 65, 67 to the AV Stream Shaper 264 to produce and output PES, PS, or TS data 215, which should be identical to the TS, PS, or ES input data 211 that entered the AVSEC 22. These operations happen in parallel to maximize throughput. The control circuit 261 then awaits the arrival of the next TCP/IP network data packet 214 from the network adapter 25.

Output from the control circuit may be Transport Stream, Program Stream, Elementary Stream, or any other format, which defines an AV streaming data protocol. The output may be played back on any appropriate output device, e.g., a general-purpose computer with a DVD decoder, an LCD TV with MPEG decoder, a traditional CRT TV with MPEG decoder, and so forth.

It is an advantage of the present invention to reduce processor and memory usage by providing a system for AV stream data transfer utilizing encapsulation hardware at a source and de-capsulation hardware at a receiver while using a standard means of networking to form a link between the encapsulating hardware to the de-capsulating hardware. Hardware encapsulation of video data is performed by loading a predetermined volume of video packets, as is, into a FIFO queue to be concatenated with an appropriate IP header. Control of header construction, data flow to/from the FIFO queue, and packet length counters can be managed locally or externally either with a microprocessor or preferably via an EEPROM configuration, saving memory and processing power. Hardware de-capsulation of received IP packet simply discards the IP header, parses the IP packet header to obtain payload length, and sends the “payload length” number of data bytes from the received packet into via a FIFO queue to the AV Stream shaper, where constant flow rate and timing gaps are reconstructed for regain the original AV stream. Parsing of the packet header is simple and can be implemented by a byte searching hardware circuit. Again, memory and processing power are saved. Additionally, in applications having Ethernet connections having bandwidth that exceeds that required by the original AV stream, the FIFO queues may be further reduced in size or possibly eliminated altogether as the required size depends merely on the header delivery times.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A hardware based AV stream encapsulation circuit (AVSEC) for encapsulating a queued segment of AV stream data into a network packet, the encapsulating circuit comprising:
a control circuit;
a packet header memory coupled to the control circuit for storing a plurality of packet header data bytes to be transmitted by the control circuit as a network packet header;
a packet header length counter coupled to the control circuit for counting the packet header data bytes transmitted by the control circuit and informing the control circuit when a last data byte of the network packet header has been transmitted;
an AV stream FIFO memory coupled to the control circuit for concatenation and queuing of a segment of the AV stream data; and
a packet payload length counter coupled to the control circuit for counting transmitted data bytes of the queued segment of AV stream data as a payload of the network packet and informing the control circuit when a last data byte of the queued segment of AV stream data has been transmitted;
wherein when the control circuit starts to concatenate the network packet header and the payload of the network packet when a first data byte of the segment of AV stream data is stored in the AV stream FIFO memory, transmits the queued segment of AV stream data as a consequence of being informed that the last data byte of the network packet header has been transmitted, and finishes the encapsulation process when informed that the last data byte of the queued segment of AV stream data has been transmitted.

2. The AV stream encapsulation circuit of claim 1, wherein the AV stream comprises a transport stream (TS), program stream (PS), or packetized elementary stream (PES).

3. The AV stream encapsulation circuit of claim 1, wherein the packet header conforms to transmission control protocol/internet protocol (TCP/IP) or user datagram protocol/internet protocol (UDP/IP).

4. The AV stream encapsulation circuit of claim 1, wherein the size of the AV stream FIFO memory is less than the number of bytes in a packet of the AV stream.

5. The AV stream encapsulation circuit of claim 1, wherein the network packet comprises a transmission control protocol/internet protocol (TCP/IP) header or a user datagram protocol/internet protocol (UDP/IP) header and at least a portion of a program stream (PS) packet or a packetized elementary stream (PES) packet as payload data.

6. The AV stream encapsulation circuit of claim 1, wherein the network packet comprises a transmission control protocol/internet protocol (TCP/IP) header or a user datagram protocol/internet protocol (UDP/IP) header and a plurality of transport stream (TS) packets as payload data.

7. The AV stream encapsulation circuit of claim 1, wherein a queued segment the AV stream data is at least a portion of a program stream (PS) packet or a portion of a packetized elementary stream (PES) packet or a plurality of transport stream (TS) packets.

8. The AV stream encapsulation circuit of claim 1, wherein transport stream (TS) data packets having removed timing relationships are concatenated as payload data, along with the network packet header, to form the network packet.

9. The AV stream encapsulation circuit of claim 1, wherein the data network comprises a network supporting transmission control protocol/internet protocol (TCP/IP) or user datagram protocol/internet protocol (UDP/IP).

10. A hardware based AV stream de-capsulation circuit (AVSDC) for receiving a network packet and de-capsulating a segment of AV stream data from the network packet, the de-capsulation circuit comprising:
a control circuit;
a packet end detector coupled to the control circuit for detecting an end of the network packet and informing the control circuit that a last data byte of the network packet is received, the packet end detector parsing a packet header to gain the packet length of the network packet and counting received data bytes of the network packet for informing the control circuit of the last data byte of the network packet;
a packet header removal counter coupled to the control circuit for storing a length of the packet header and informing the control circuit when a last data byte of the packet header is removed;
an AV stream FIFO memory coupled to the control circuit for queuing the segment of AV stream data de-capsulated from a payload of the network packet; and
an AV stream shaper coupled to the AV stream FIFO memory for receiving the queued segment of AV stream data and for outputting a timing rebuilt AV stream, wherein the AV stream shaper receives clustered AV stream packets from the AV stream FIFO and reconstructs the AV stream with timing rebuilt having constant flow rate and timing gaps determined by parameters during initialization;
wherein the control circuit starts to separate the network packet header and the payload of the network packet when the first data byte of the network packet is received, delivers the de-capsulated segment of AV stream data to the AV stream FIFO memory after the last data byte of the network packet header has been removed, and finishes the de-capsulation process when the last data byte of the network packet is received.

11. The AV stream de-capsulation circuit of claim 10, wherein the network packet length in the packet end detector can also be determined by parameters during initialization.

12. The AV stream de-capsulation circuit of claim 10, wherein the job of the packet end detector parsing the network packet length from the network packet header is implemented by a byte searching hardware circuit.

13. The AV stream de-capsulation circuit of claim 10, wherein the AV stream shaper reconstructs the AV stream comprising transport stream (TS), program stream (PS), or packetized elementary stream (PES) which utilize constant flow rate and timing gap information determined by parameters during initialization.

14. A method for an AV stream encapsulation circuit (AVSEC) to encapsulate a segment of AV stream data, the method comprising the following steps:
(1) generating a network protocol data packet header;
(2) storing the network protocol data packet header in a packet header memory block;
(3) configuring a packet header length counter according to a length of the network protocol data packet header;
(4) configuring a packet payload length counter according to the length of a stored segment of AV stream data;
(5) loading and storing the segment of AV stream data into an AV stream FIFO memory according to a continue counting state of the packet payload length counter;
(6) concatenating the network protocol data packet header and the stored segment of AV stream data by sequentially outputting the network protocol data packet header according the length indicated by the packet header length counter and the stored segment of AV stream data according to the length indicated by the packet payload length counter;
(7) enabling loading of a next sequential segment of AV stream data according to a counting end state of the packet payload length counter; and
(8) repeating step (5) to step (7) whenever a configuration environment of the AVSEC does not change and AV stream encapsulation continues.

15. A method for an AV stream de-capsulation circuit (AVSDC) de-capsulating a segment of AV stream data, the method comprising the following steps:
(1) configuring an AV stream shaper to define output AV stream format, output stream rate, AV stream packet length, and constant gap time between two AV stream packets;
(2) configuring a packet header removal counter according to a length of a network protocol data packet header;
(3) inputting a network protocol data packet to the de-capsulation circuit;
(4) configuring a packet end detector according to a length of a network packet payload;
(5) removing the network protocol data packet header according to the packet header removal counter;
(6) loading and storing a segment of AV stream data comprised by the network packet payload into an AV stream FIFO memory according to a continue receiving state of a packet end detector;
(7) the AV stream shaper reading AV data from the AV stream FIFO memory and outputting an AV stream according to the step (1) configured AV stream format;
(8) enabling loading of a next sequential network protocol data packet according to a packet end state of the packet end detector; and
(9) repeating step (3) to step (8) whenever a configuration environment of the AVSDC does not change and AV stream de-capsulation continues.

16. The method of claim 15, wherein step (2) length of a network protocol data packet header can be obtained by parsing the network protocol data packet header.

17. The method of claim 15, wherein step (4) length of the network packet payload can be obtained by parsing the network protocol data packet header.
